(19) United States
(12) Patent Application Publication
(10) Pub. No.: US 2016/0008953 A1
(43) Pub. Date: Jan. 14, 2016

(54) MAGNETIC LINER SYSTEM FOR CENTRIFUGAL BLAST WHEEL MACHINE AND METHOD OF ASSEMBLING A MAGNETIC LINER SYSTEM

(71) Applicant: WHEELABRATOR GROUP, INC., Golden, CO (US)

(72) Inventor: Raymond Paul Bitzel, JR., Newnan, GA (US)

(21) Appl. No.: 14/328,827

(22) Filed: Jul. 11, 2014

(51) Int. Cl. B24C 5/06; B32B 37/12; B32B 37/02; B32B 37/18

(52) U.S. Cl. CPC B24C 5/066; B32B 37/18; B32B 37/1292; B32B 37/02; B32B 2307/208

(57) ABSTRACT

A centrifugal blast wheel machine includes a housing, a wheel assembly configured to throw blast media introduced into the wheel assembly against a work piece, and an impeller positioned about an axis of the wheel assembly. The impeller has a media inlet at one end adapted to receive blast media and a plurality of impeller media outlets configured to allow egress of blast media upon rotation of the impeller. The blast wheel machine further includes a motor coupled to the impeller to drive the rotation of the impeller and the wheel assembly. The blast wheel machine further includes a magnetic liner secured to the left side wall and the right side wall to create an enclosure. The magnetic liner has a plurality of magnets arranged so that North poles of the plurality of magnets are positioned on a common side to attract a layer of ferrous material.

BACKGROUND OF THE DISCLOSURE

1. Field of the Disclosure

The present disclosure relates generally to abrasive blast wheels and methods for cleaning or treating surfaces of work pieces, and more particularly to a magnetic liner system for a centrifugal blast wheel machine and to methods of assembling a magnetic liner system.

2. Discussion of Related Art

Centrifugal blasting wheels generally include a rotatable hub to which is mounted a plate or a pair of spaced plates which carry radially extending blades. Particulate matter is discharged from a center of the wheel onto rotating surfaces of the blades, which propel the particulate matter against surfaces of a work piece to be cleaned or treated. Specifically, blast media is fed from a feed spout into a rotating impeller situated within a control cage at the center of the blast wheel. The media is fed from the impeller, though an opening in a control cage and onto the heel or inner ends of the rotating blades. The media travels along the faces of the blades and is thrown from the tips of the blades at the work piece surfaces to be treated.

Current centrifugal blast wheels offer some form of replaceable wear protection from the continuous erosion of blast media accelerated through the rotatable hub of the blast wheel. This replaceable protection includes a variety of materials (alloys) in the form of casted alloy plates placed in strategic areas within the wheel housing. Replacing existing liner materials is costly and difficult to perform.

### SUMMARY OF THE DISCLOSURE

One embodiment of the disclosure is directed to a centrifugal blast wheel machine comprising a housing having a mounting flange, a left side wall mounted on the mounting flange, and a right side wall mounted on the mounting flange. The left side wall is spaced from the right side wall. The centrifugal blast wheel machine further comprises a wheel assembly having a plurality of blades configured to throw blast media introduced into the wheel assembly against a work piece, and an impeller positioned about an axis of the wheel assembly. The impeller has a media inlet at one end adapted to receive blast media and a plurality of impeller media outlets constructed and arranged to allow egress of blast media upon rotation of the impeller. The centrifugal blast wheel machine further comprises a control cage surrounding the impeller and having a cage media outlet adapted for passage of blast media, and a motor coupled to the impeller to drive the rotation of the impeller and the wheel assembly. The centrifugal blast wheel machine further comprises a magnetic liner secured to the left side wall and the right side wall to create an enclosure. The magnetic liner has a plurality of magnets arranged so that North poles of the plurality of magnets are positioned on a common side to attract a layer of ferrous material.

Embodiments of the centrifugal blast wheel machine further may include arranging the plurality of magnets in a reinforced channel to prevent gaps in a field and create a uniform protective abrasive layer. The plurality of magnets may be arranged so that the plurality magnets are glued in subgroups and forcibly jacked into the reinforced channel. The arrangement of the plurality of magnets may be particularly suited for linear surfaces. The plurality of magnets may be arranged by placing low power magnets into the reinforced channel and glued to one another to achieve a continuous high power magnetic field. The arrangement of the plurality of magnets may be particularly suited for curved surfaces.

Another aspect of the present disclosure is directed to a method of assembling a magnetic liner for a centrifugal blast wheel machine. In one embodiment, the method comprises: providing a jig having a channel and a clamping mechanism; positioning a first magnet into the channel; applying an adhesive on a surface of the first magnet; positioning a second magnet into the channel so that the second magnet engages the surface of the first magnet having the adhesive; and clamping the first and second magnets so that the first and second magnets adhere to one another. The first magnet and the second magnet are arranged so that North poles of the first magnet and the second magnet are positioned on a common side to attract a layer of ferrous material.

Embodiments of the method further may include positioning additional magnets into the channel, applying adhesive on adjacent surfaces of the additional magnets, and clamping the additional magnets to adhere them to one another. The method further may include removing a reinforced channel containing the assembled magnets from the jig and securing the reinforced channel containing the assembled magnets to a housing of the centrifugal blast wheel machine to create the magnetic liner.

A further aspect of the disclosure is directed to another method of assembling a magnetic liner for a centrifugal blast wheel machine. In one embodiment, the method comprises: providing a reinforced channel configured to receive magnets therein; positioning a first magnet into the reinforced channel; applying an adhesive on a surface of the first magnet; positioning a second magnet into the reinforced channel so that the second magnet engages the surface of the first magnet having the adhesive; and securing the reinforced channel to a housing of the centrifugal blast wheel machine to create the magnetic liner. The first magnet and the second magnet are arranged in the reinforced channel so that North poles of the first magnet and the second magnet are positioned on a common side to attract a layer of ferrous material. The method further may include positioning additional magnets into the channel and applying adhesive on adjacent surfaces of the additional magnets.

Yet another aspect of the disclosure is directed to a magnetic liner for a centrifugal blast wheel machine. The magnetic liner comprises a plurality of magnets arranged so that North poles of the plurality of magnets are positioned on a common side to attract a layer of ferrous material.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic perspective view showing an assembly of individual magnets;

FIG. 2 is a view showing a magnetic liner having magnets arranged in a North-North manner;

FIG. 3 is a perspective view of a jig used to fabricate the magnetic liner;

FIG. 4 is a cross-sectional view of a reinforced channel having magnets;

FIG. 5A is a perspective view of a portion of a centrifugal blast wheel machine having the magnetic liner;

FIG. 5B is another perspective view of the centrifugal blast wheel machine having the magnetic liner;

FIG. 6 is an exploded perspective view of the centrifugal blast wheel machine; and

FIG. 7 is a perspective view of the magnetic liner.

### DETAILED DESCRIPTION

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The principles set forth in this disclosure are capable of other embodiments and of being practiced or carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The present disclosure is directed to a magnetic liner for a centrifugal blast wheel machine. The magnetic liner is applied to strategic areas of the centrifugal blast wheel machine on which a sacrificial layer of ferrous material is applied to protect the strategic areas of the centrifugal blast wheel machine. Although the present disclosure will be described more fully in the surface treatment context, it is contemplated that the magnetic liner can find utility in any type of application where abrasive material is being applied to surfaces requiring protection.

The magnetic liner of the present disclosure is designed to eliminate the need for all forms of replaceable wear plates within the blast wheel by creating a specific and defined magnetic field to hold a sacrificial layer of ferrous media/abrasive to the magnetic liner thus eliminating the need for conventional cast liner replacements. The preventing of wear is due to abrasive striking the sacrificial ferrous layer, which is replaced with available abrasive within the wheel, rather than abrasive striking a casted wear plate.

In one embodiment, the magnets are fabricated from materials that are capable of producing a magnetic field, which is capable of attracting ferromagnetic materials, such as blast media including iron. In a particular embodiment, the magnets are permanent magnets, which are made from material that is magnetized to create a permanent magnetic field. Such materials may include iron, nickel, cobalt, and alloys of rare earth metals. In a certain embodiment, the magnets are fairly large, e.g., 3½ inches wide by 1½ inches long by 1½ inches high.

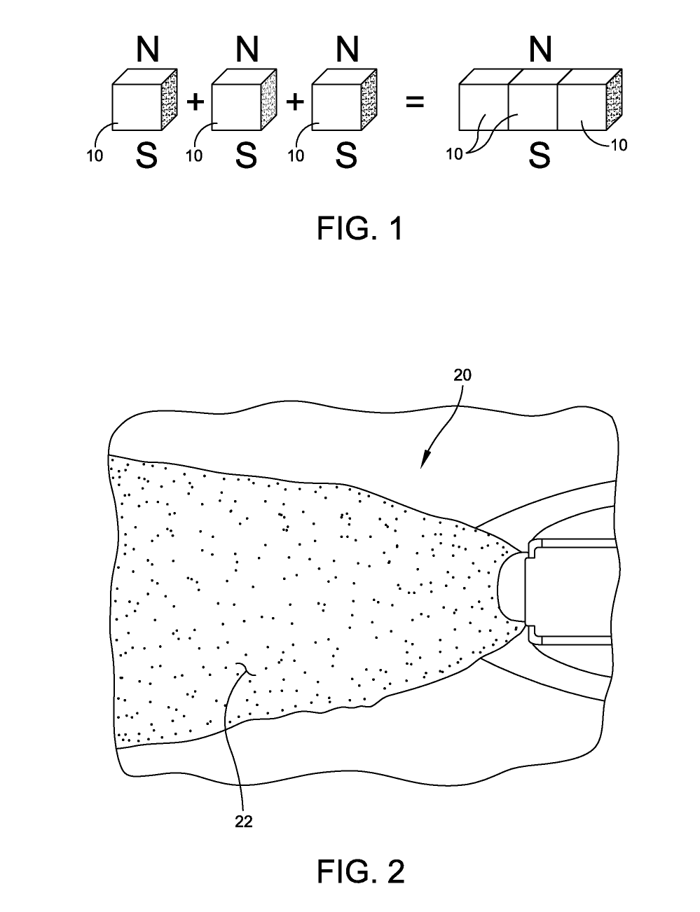

Referring to the drawings, and more particularly to FIG. 1, individual magnets, each indicated at 10, are assembled first in North-North position, meaning a continuous north direction of magnetism (DOM) surface is positioned to attract a non-interrupted field of abrasive. The position of the magnets 10 in a North-North arrangement is critical, since without this arrangement, weak fields are created between the North-South magnetic fields causing loss of abrasive coverage leading to failure of the lining system. The creation of a North-North arrangement prevents gaps in the field and creates a uniform protective abrasive layer. Since magnets' North and South poles attract each other, and North and North poles oppose/repel one another, the design creates a unique manufacturing challenge. As discussed below, the magnets 10 may be more powerful or less powerful depending on the application.

Disclosed herein are two methods for assembling the magnets depending on the shape of the magnetic liner desired. As shown, the magnets 10 arranged so that North poles of the magnets are positioned on a common side to attract a layer of ferrous material to protect a lid of the centrifugal blast wheel machine, for example. Although three such magnets 10 are shown in FIG. 1, any number of magnets may be arranged and assembled in the manner discussed below to achieve a magnetic liner of embodiments of the present disclosure.

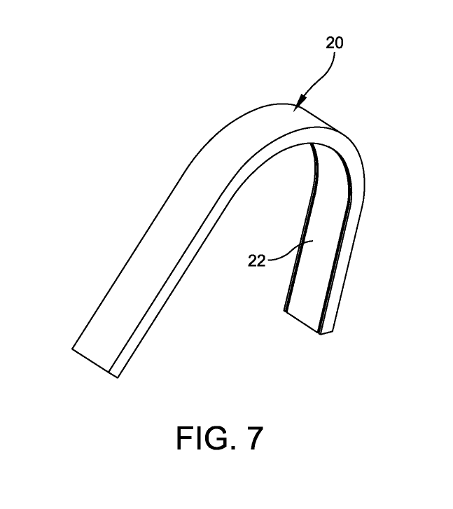

FIG. 2 illustrates a magnetic liner, generally indicated at 20, secured to a centrifugal blast wheel machine to create an interior suitable for treating work pieces. As shown, the magnetic liner 20 having a continuous north direction of magnetism (DOM) surface 22 is positioned to attract a non-interrupted field of abrasive. The magnetic liner 20 is applied to strategic areas, primarily replacing the conventional “end” and “top” liners. In some embodiments, the magnetic liner 20 replaces a lid of the centrifugal blast wheel machine. In a certain embodiment, the magnetic liner is a continuous member that covers the entire ends and top of the blast wheel (see FIG. 7). The magnetic liner 20 functions as the lid, meaning there are no fasteners, which adds to the ease of maintenance and overall lower operating costs. A separate “lid” may be provided as an aesthetic plastic cover.

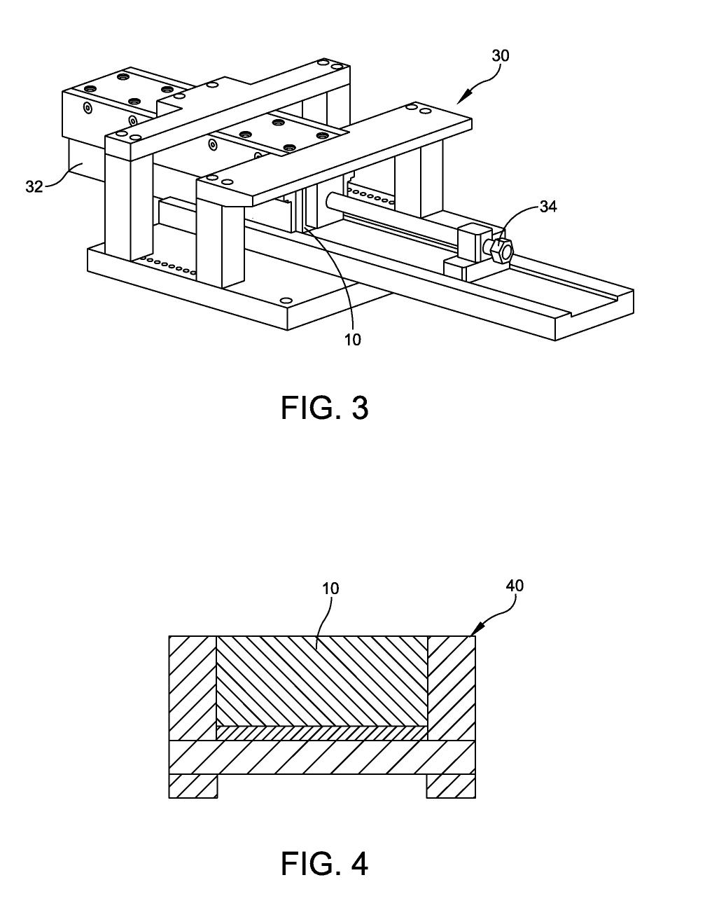

Referring to FIG. 3, one method of assembling the magnets is directed to arranging powerful magnets 10 in a jig, generally indicated at 30, so that the magnets 10 are glued in subgroups and forcibly “jacked”' into a reinforced channel 32, in which other subgroups are then also glued into and placed. In one embodiment, a clamping mechanism 34 is provided for clamping the magnets 10. This process is most economical and used for straight magnetic liner designs. The reinforced channel 32 containing the magnets 10 is then suitably secured between housing side walls from atop of the channel to keep the channel strength intact as well as reducing any possible magnetic field distortion from ferritic/ferrous fasteners.

Details of the method of assembling the magnetic liner 20 include providing the jig 30 having the reinforced channel 32 and the clamping mechanism 34. Next, a first magnet 10 is positioned into the reinforced channel 32, and an adhesive is applied on a surface of the first magnet. Next, a second magnet 10 is positioned into the reinforced channel 32 so that the second magnet engages the surface of the first magnet 10 having the adhesive. After, the first and the second magnets are clamped so that the first and second magnets adhere to one another with the clamping mechanism 34. The method can further include positioning additional magnets 10 into the reinforced channel 32 of the jig 30, applying adhesive on adjacent surfaces of the additional magnets, and clamping the additional magnets to adhere them to one another with the clamping mechanism 34. After the adhesive cures, the reinforced channel 32 containing the assembled magnets 10 is removed from the jig and secured to a housing of the centrifugal blast wheel machine to create the magnetic liner 20.

Referring to FIG. 4, another method is directed to arranging low power magnets 10 directly into a reinforced channel 40, and glued to one another to achieve a continuous high power magnetic field. As shown, the reinforced channel 40 further includes a bottom plate fabricated from a ferrous alloy for ease of manufacturing while the channel material is made from a high-strength austenitic alloy for propagate the magnetic field evenly through the nearby ferrous centrifugal blast wheel housing side walls. The low power magnet strength is then increased by placing the reinforced channel 40 and magnets 10 into a magnetizer while applying high voltage. The strength of the voltage (magnetic field) is directly proportional to the final magnet assembly power. The magnetic field is created around the assembly, significantly increasing the magnet strength to desired specification. This process is used for curved liner shapes. As with the jig 30 shown in FIG. 3, the reinforced channel 40 containing the magnets 10 is then suitably secured to the wall of the centrifugal blast wheel machine requiring protection.

Details of this method of assembling a magnetic liner by positioning a first magnet 10 into the reinforced channel 40. Next, adhesive is applied on a surface of the first magnet 10, and a second magnet 10 is positioned into the reinforced channel 40 so that the second magnet engages the surface of the first magnet having the adhesive. Additional magnets 10 may be positioned in the reinforced channel 40 with adhesive being applied on adjacent surfaces of the additional magnets to secure the magnets to one another. Once cured, the reinforced channel 40 with magnets 10 is placed into a magnetizing fixer and a specific voltage is applied to create an electrical field to increase the magnets 10 to the required strength. Then, the bottom plate of the reinforced channel 40 is secured to a housing of the centrifugal blast wheel machine to create the magnetic liner 20.

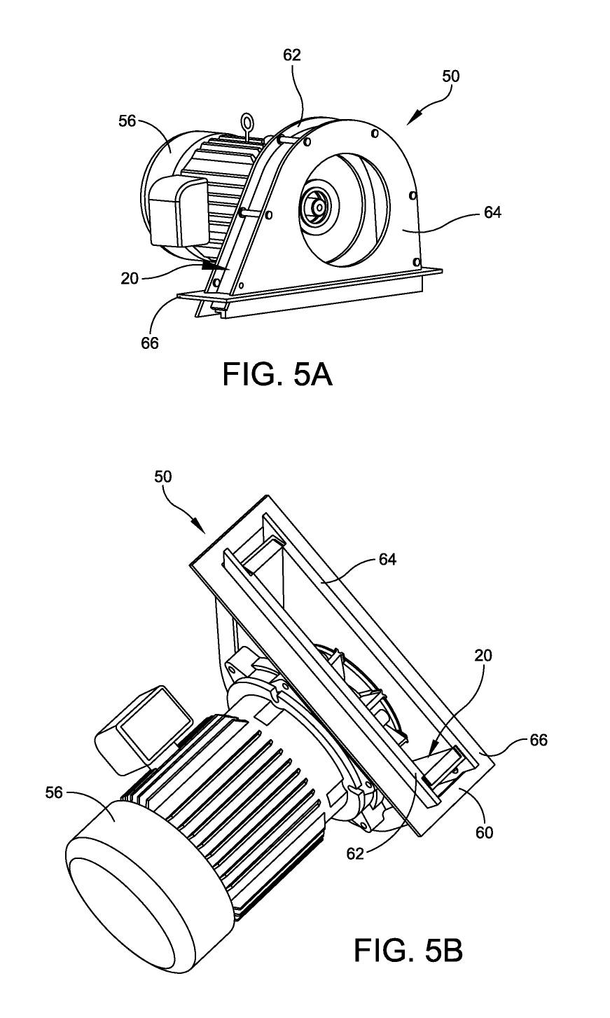

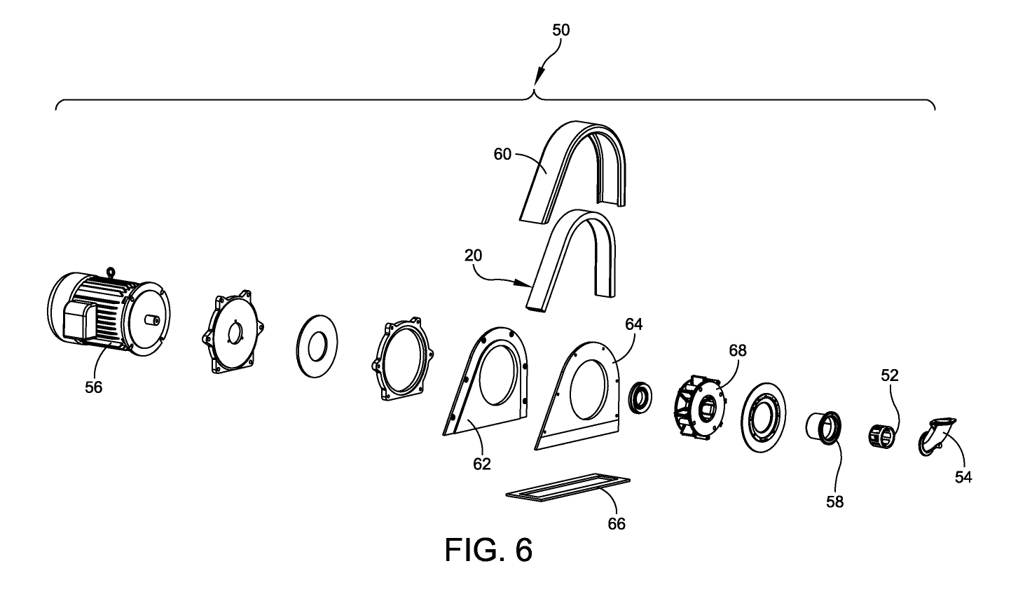

The operation of a centrifugal blast wheel machine, generally indicated at 50, can be understood by reference to FIGS. 5A, 5B and 6. As shown, blast media is fed from a feed spout 52 into a rotating impeller 54, which is driven by a motor 56. By contact with the rotating impeller vanes (as well as with other particles of media already in the impeller 54), blast media particles are accelerated, giving rise to a centrifugal force that moves the particles in radial direction, away from the axis of the impeller 54. The particles, now moving in a generally circular direction as well as outwards, move through impeller openings into a space between the impeller and a control cage 58, still being carried by the movement of the impeller vanes and the other particles.

When the particles that have passed though the impeller openings into the space between the impeller 54 and the control cage 58 reach an opening provided in the control cage, rotational and centrifugal forces move the particles through the opening and onto ends of the vanes. The control cage 58 functions to meter a consistent and appropriate amount of blast media onto the vanes. As the vanes rotate, the particles are moved along their lengths and accelerate until they reach the ends of the vanes and thrown from the ends of the vanes.

The magnetic liner 20 is secured to the housing of the centrifugal blast wheel machine to create an enclosure in which the work piece is positioned for treatment. A lid 60 of the centrifugal blast wheel machine 50 may be provided over the magnetic liner 20 for aesthetic purposes. Other component parts of the centrifugal blast wheel machine 50 can also include the magnetic 20 liner to protect those parts as well. For example, housing walls 62, 64 of the centrifugal blast wheel machine 50 also may be lined with the magnetic liner 20. As shown, the housing walls 62, 64 are mounted on a mounting flange 66, with the left housing wall 62 being spaced from the right housing wall 64.

A wheel assembly 68 having a plurality of blades is further provided to throw blast media introduced into the wheel assembly to treat the work piece. The arrangement is such that the impeller 54 is positioned about an axis of the wheel assembly 68, with the impeller having a media inlet at one end adapted to receive blast media and a plurality of impeller media outlets constructed and arranged to allow egress of blast media upon rotation of the impeller. The control cage 58 surrounds the impeller 54 and has a cage media outlet adapted for passage of blast media to the heel ends of the vanes. As mentioned above, the motor 56 is coupled to the impeller 54 to drive the rotation of the impeller and the wheel assembly 68.

The reinforced channels 32, 40 holding the magnets 10 are also very important. Magnets cannot be placed onto a steel surface and provide the safety needed in the event of a wheel failure. The reinforced channels 32, 40 are designed to hold magnets and all flying debris (blades, control cage, impeller, etc.) in the event of a wheel failure. The glue/fasteners/stainless steel alloy/shape all contribute to overall rigidity.

In some embodiments, the strength of each magnet is varied depending on application and shape of blast wheel housing unit. The strength of each magnet can vary between 1,000 Gauss/1 Tesla to 6,000 Gauss/6 Tesla.

The magnetic liner may also be configured to achieve a certain heat resistance. For example, heat resistance may be considered to accommodate various applications from 80° C. to 160° C. by selecting properly rated magnet with proper depth/dimensions (heat sink). Having a sufficient heat resistance is somewhat important as the magnets can permanently degrade upon reaching is max rated temperature.

The shape of the magnetic liner is dependent on application, and thus wide variations in width, length and curve angle are needed.

In one embodiment, and with reference to FIG. 7, the magnetic liner 20 is a continuous member, replacing four replaceable end liners and one replaceable top liner with adjustable retaining bolts and lid for access. A sacrificial abrasive media layer 22 is provided to eliminate need for wear plates reducing customers cost of ownership by reduction of wear parts and maintenance and increased uptime.

The magnetic liner of embodiments of the present disclosure offers the end user the benefit of lower operating cost.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

What is claimed is:

1. A centrifugal blast wheel machine comprising:
a housing having a mounting flange, a left side wall mounted on the mounting flange, and a right side wall mounted on the mounting flange, the left side wall being spaced from the right side wall;
a wheel assembly having a plurality of blades configured to throw blast media introduced into the wheel assembly against a work piece;
an impeller positioned about an axis of the wheel assembly, the impeller having a media inlet at one end adapted to receive blast media and a plurality of impeller media outlets constructed and arranged to allow egress of blast media upon rotation of the impeller;
a control cage surrounding the impeller and having a cage media outlet adapted for passage of blast media;
a motor coupled to the impeller to drive the rotation of the impeller and the wheel assembly, and
a magnetic liner secured to the left side wall and the right side wall to create an enclosure, the magnetic liner having a plurality of magnets arranged so that North poles of the plurality of magnets are positioned on a common side to attract a layer of ferrous material.

2. The centrifugal blast wheel machine of claim 1, wherein the plurality of magnets are arranged in a reinforced channel to prevent gaps in a field and create a uniform protective abrasive layer.

3. The centrifugal blast wheel machine of claim 2, wherein the plurality of magnets are arranged so that the plurality magnets are glued in subgroups and forcibly jacked into the reinforced channel.

4. The centrifugal blast wheel machine of claim 3, wherein the arrangement of the plurality of magnets is particularly suited for linear surfaces.

5. The centrifugal blast wheel machine of claim 2, wherein the plurality of magnets are arranged by placing low power magnets into the reinforced channel and glued to one another to achieve a continuous high power magnetic field.

6. The centrifugal blast wheel machine of claim 5, wherein the arrangement of the plurality of magnets is particularly suited for curved surfaces.

7. A method of assembling a magnetic liner for a centrifugal blast wheel machine, the method comprising:
providing a jig having a reinforced channel and a clamping mechanism;
positioning a first magnet into the reinforced channel;
applying an adhesive on a surface of the first magnet;
positioning a second magnet into the reinforced channel so that the second magnet engages the surface of the first magnet having the adhesive; and
clamping the first and second magnets so that the first and second magnets adhere to one another,
wherein the first magnet and the second magnet are arranged so that North poles of the first magnet and the second magnet are positioned on a common side to attract a layer of ferrous material.

8. The method of claim 7, further comprising positioning additional magnets into the reinforced channel, applying adhesive on adjacent surfaces of the additional magnets, and clamping the additional magnets to adhere them to one another.

9. The method of claim 8, further comprising removing the reinforced channel containing the assembled magnets from the jig.

10. The method of claim 9, further comprising securing the reinforced channel containing the assembled magnets to a housing of the centrifugal blast wheel machine to create the magnetic liner.

11. A method of assembling a magnetic liner for a centrifugal blast wheel machine, the method comprising:
providing a reinforced channel configured to receive magnets therein;
positioning a first magnet into the reinforced channel;
applying an adhesive on a surface of the first magnet;
positioning a second magnet into the reinforced channel so that the second magnet engages the surface of the first magnet having the adhesive; and
securing the reinforced channel to a housing of the centrifugal blast wheel machine to create the magnetic liner,
wherein the first magnet and the second magnet are arranged in the reinforced channel so that North poles of the first magnet and the second magnet are positioned on a common side to attract a layer of ferrous material.

12. The method of claim 11, further comprising positioning additional magnets into the reinforced channel and applying adhesive on adjacent surfaces of the additional magnets.

13. A magnetic liner for a centrifugal blast wheel machine, the magnetic liner comprising:
a plurality of magnets arranged so that North poles of the plurality of magnets are positioned on a common side to attract a layer of ferrous material.

14. The magnetic liner of claim 13, wherein the plurality of magnets are arranged in a reinforced channel to prevent gaps in a field and create a uniform protective abrasive layer.

15. The magnetic liner of claim 14, wherein the plurality of magnets are arranged so that the plurality magnets are glued in subgroups and forcibly jacked into the reinforced channel.

16. The magnetic liner of claim 15, wherein the arrangement of the plurality of magnets is particularly suited for linear surfaces.

17. The magnetic liner of claim 14, wherein the plurality of magnets are arranged by placing low power magnets into the reinforced channel and glued to one another to achieve a continuous high power magnetic field.

18. The magnetic liner of claim 17, wherein the arrangement of the plurality of magnets is particularly suited for curved surfaces.
